(19) United States
(12) Patent Application Publication
(10) Pub. No.: US 2023/0259911 A1
(43) Pub. Date: Aug. 17, 2023

(54) TRANSACTION PROCESSING SYSTEM, TRANSACTION PROCESSING APPARATUS, AND INFORMATION PROCESSING METHOD

(71) Applicant: TOSHIBA TEC KABUSHIKI KAISHA, Tokyo (JP)

(72) Inventors: Kenji SAKURAI, Mishima Shizuoka (JP); Taishi SANO, Yokohama Kanagawa (JP); Toru TERAUCHI, Nerima Tokyo (JP)

(21) Appl. No.: 17/994,950

(22) Filed: Nov. 28, 2022

(30) Foreign Application Priority Data
Feb. 14, 2022 (JP) 2022-020736

(51) Int. Cl. G06Q 20/20; G06Q 20/14

(52) U.S. Cl. CPC G06Q 20/20; G06Q 20/14

(57) ABSTRACT

A transaction processing system for retail stores includes a content management apparatus storing content files and a transaction processing apparatus. The transaction processing apparatus is configured to register a commodity in a transaction based on registration input received from a user terminal device and select a content file to be displayed on the user terminal from the content files stored on the content management apparatus. The content file is selected based on a user attribute associated with a user of the user terminal device or a commodity registered in the transaction. When a length of time since a registration input was last received without another registration input or user instruction being received exceeds a timeout period, the transaction processing apparatus causes the user terminal device to display information corresponding to the selected content file.

### CROSS-REFERENCE TO RELATED APPLICATION

This application is based upon and claims the benefit of priority from Japanese Patent Application No. 2022-020736, filed Feb. 14, 2022, the entire contents of which are incorporated herein by reference.

### FIELD

Embodiments relate to a transaction processing system, a transaction processing apparatus, and an information processing method for retail stores and the like.

### BACKGROUND

A retail transaction processing system that uses a communication terminal, such as a smartphone, that is owned by a customer as a user interface for a point-of-sale (POS) terminal or the like can be referred to as a “smartphone POS system.”

However, in this type of system, information about various sales promotions might not be easily provided to customer terminal beforehand to be used during shopping.

In view of such circumstances, systems, devices, and methods for better providing sales promotion information to customers using smartphone POS systems or the like is desired.

### BRIEF DESCRIPTION OF THE DRAWINGS

FIG. 1 is a block diagram of a transaction processing system.

FIG. 2 is a flowchart of user interface (UI) processing executed by a processor provided in a user terminal.

FIG. 3 is a flowchart of additional aspects of UI processing.

FIG. 4 is a flowchart of transaction processing executed by a processor in a transaction processing apparatus.

FIG. 5 is a diagram showing an example of a registration screen.

FIG. 6 is a diagram showing an example of a display screen of a touch panel.

FIG. 7 is a diagram showing an example of a display screen of a touch panel.

### DETAILED DESCRIPTION

In general, according one embodiment, a transaction processing system, a transaction processing apparatus, and an information processing program that can provide information for sales promotion to a communication terminal used as a user interface for transaction processing are provided.

According to one embodiment, a retail store transaction processing system includes a content management apparatus with a plurality of content files and a transaction processing apparatus.

The transaction processing apparatus is communicatively connected to the content management apparatus and configured to: register a commodity in a transaction based on registration input received from a user terminal device; select a content file to be displayed on the user terminal from the plurality of content files stored on the content management apparatus, the content file being selected based on at least one of a user attribute associated with a user of the user terminal device and a commodity that has been registered in the transaction; and, during the transaction, detect when a length of time since a registration input has been received from the user terminal device without receiving another registration input or user instruction exceeds a timeout period and cause the user terminal device to display information corresponding to the selected content file after the length of time exceeds the timeout period.

Hereinafter, an example embodiment will be described with reference to the drawings.

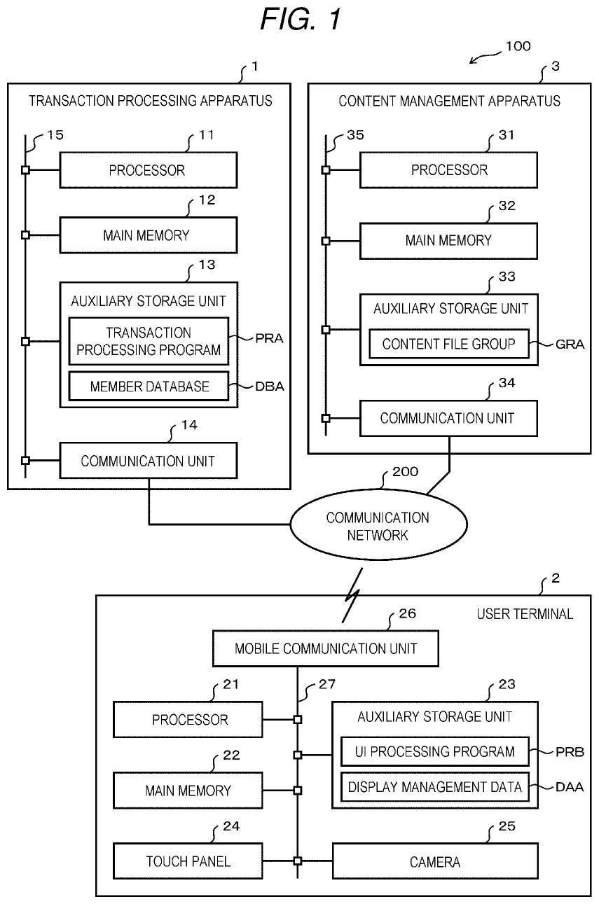

FIG. 1 is a block diagram showing a schematic configuration of a transaction processing system 100.

In the transaction processing system 100, a transaction processing apparatus 1, a user terminal 2, and a content management apparatus 3 can communicate with one another via a communication network 200. Any number of transaction processing apparatuses 1, user terminals 2, and content management apparatuses 3 may be included in the transaction processing system 100, but, for representational convenience, only one transaction processing apparatus 1, one user terminal 2, and one content management apparatus 3 are shown in FIG. 1. In some examples, the content management apparatus 3 need not be separately included in the transaction processing system 100 may be integrated with the transaction processing apparatus 1. In other examples, the content management apparatus 3 may be combined or provided as part of an apparatus that manages aspects for another service provided by a store, store system, or the like.

The transaction processing apparatus 1 performs information processing for processing a merchandise sales transaction between a customer and a store in accordance with merchandise registration operations performed by the customer in the store using the user terminal 2 as a user interface terminal. The transaction processing apparatus 1 is implemented as a cloud server and performs transaction processing for a plurality of stores. In other examples, the transaction processing apparatus 1 may be implemented as a local server and perform transaction processing for just one store.

The user terminal 2 is an information processing terminal carried by a customer. The user terminal 2 is typically owned by a customer and brought into a store and used by the customer. The user terminal 2 receives merchandise registration operations and other input operations performed by the customer and provides data for transaction processing (merchandise registration) by the transaction processing apparatus 1.

The content management apparatus 3 manages information (sales promotion information) to be presented to customers for sales promotion. The content management apparatus 3 is implemented as a cloud server and manages sales promotion content for a plurality of stores. In other examples, the content management apparatus 3 may be implemented as a local server and manage sales promotion content for just one store.

As the communication network 200, the Internet, a virtual private network (VPN), a LAN, a public communication network, a mobile communication network, or the like may be used alone or in combination as appropriate. As the communication network 200, for example, the Internet and a mobile (cellular) communication network are used in combination.

The transaction processing apparatus 1 includes a processor 11, a main memory 12, an auxiliary storage unit 13, a communication unit 14, a transmission path 15, and the like. The processor 11, the main memory 12, the auxiliary storage unit 13, and the communication unit 14 can communicate with each other via the transmission path 15.

The processor 11 corresponds to a central processing unit (CPU) of a computer. The processor 11 executes information processing to implement various functions of the transaction processing apparatus 1. Such information processing may be based on instructions of an operating system and/or an information processing program such as an application program or other software type program.

The main memory 12 includes a read-only memory area and a rewritable memory area. The main memory 12 may store an information processing program in read-only memory area. In addition, the main memory 12 may store, in a read-only memory area or a rewritable memory area, data necessary for the processor 11 to execute processing. In the main memory 12, a rewritable memory area is used as a work area for the processor 11.

As the auxiliary storage unit 13, for example, an electric erasable programmable read-only memory (EEPROM), a hard disc drive (HDD), a solid-state drive (SSD), or other various types of storage devices may be used. The auxiliary storage unit 13 stores data used by the processor 11 to perform various types of processing along with the data generated by the processor 11. The auxiliary storage unit 13 may store an information processing program. In the present embodiment, the auxiliary storage unit 13 stores a transaction processing program PRA. The transaction processing program PRA is an application program in which program instructions for implementing a procedure for transaction processing is recorded. A part of a storage area of the auxiliary storage unit 13 is used as an area for storing a member database DBA. The member database DBA is a database for managing members who are registered or the like use a smartphone POS service.

The communication unit 14 executes communication processing for performing data communication via the communication network 200. As the communication unit 14, for example, an existing communication device for the Internet may be used.

The transmission path 15 includes an address bus, a data bus, a control signal line, and the like, and transmits data and a control signal between the connected units.

As hardware of the transaction processing apparatus 1, a general-purpose server device may be used. The transaction processing apparatus 1 can be provided with the transaction processing program PRA already stored in the auxiliary storage unit 13. However, the hardware without the transaction processing program PRA stored in the auxiliary storage unit 13 can be provided and the transaction processing program PRA may be later provided and installed in the transaction processing apparatus 1. In some examples, an application program of the same general type as the transaction processing program PRA may be stored in the auxiliary storage unit 13 at transfer of the transaction processing apparatus 1 and the transaction processing program PRA may subsequently transferred or the previously loaded application program may be updated to transaction program PRA. Transfer of the transaction processing program PRA can be performed by recording the transaction processing program PRA on a non-transitory, computer-readable removable recording medium such as a magnetic disk, a magneto-optical disk, an optical disk, or a solid-state semiconductor memory device, or by download via a network.

The user terminal 2 includes a processor 21, a main memory 22, an auxiliary storage unit 23, a touch panel 24, a camera 25, a mobile communication unit 26, a transmission path 27, and the like. The processor 21, the main memory 22, the auxiliary storage unit 23, the touch panel 24, the camera 25, and the mobile communication unit 26 can communicate with one another via the transmission path 27.

In general, the basic functions of the processor 21, the main memory 22, the auxiliary storage unit 23, and the transmission path 27 are substantially the same as those of the processor 11, the main memory 12, the auxiliary storage unit 13, and the transmission path 15, already described, and thus additional description thereof will be omitted. The auxiliary storage unit 23 particularly stores a user interface (UI) processing program PRB rather than transaction processing program PRA. The UI processing program PRB is an application program in which a procedure associated with UI processing described below is recorded. A part of a storage area of the auxiliary storage unit 23 is used to store display management data DAA. The display management data DAA is data for managing content to be displayed to a customer using the user terminal 2.

The touch panel 24 functions as an input device and a display device of the user terminal 2.

The camera 25 includes an optical system and an image sensor, and the image sensor generates image data representing an image in a field of view formed by the optical system.

The mobile communication unit 26 is an interface for data communication via the communication network 200. As the mobile communication unit 26, for example, a known communication device for performing data communication via a mobile communication network may be used.

The content management apparatus 3 includes a processor 31, a main memory 32, an auxiliary storage unit 33, a communication unit 34, a transmission path 35, and the like. The processor 31, the main memory 32, the auxiliary storage unit 33, and the communication unit 34 can communicate with one another via the transmission path 35.

In general, the basic functions of the processor 31, the main memory 32, the auxiliary storage unit 33, the communication unit 34, and the transmission path 35 are substantially the same as those of the processor 11, the main memory 12, the auxiliary storage unit 13, the communication unit 14, and the transmission path 15, and thus additional description thereof will be omitted.

The auxiliary storage unit 33 stores an information processing program for content management. A part of a storage area of the auxiliary storage unit 33 is used to store a content file group GRA. The content file group GRA is a set of content files. Each content file represents different content to be displayed on the user terminal 2 for sales promotion.

Next, operations of the transaction processing system 100 will be described. The specifics of processing and content described below are merely examples, and it is possible to appropriately change an order of some processing, omit some processing, add other processing, substitute other processing and the like. In the following description, the description of some processing may be omitted in order to describe characteristic operations of the present embodiment in an easy-to-understand manner. For example, when an error occurs, processing for coping with the error may be performed, but specific description of such error processing is generally omitted.

In the following description, the service provided to a customer by the transaction processing system 100 is referred to as a “smartphone POS service” but other names for similar functions may be adopted.

A provider who wants to provide a content for sales promotion to a customer who uses the smartphone POS service uploads a content file to the content management apparatus 3 via, for example, the communication network 200. In response to this, the processor 31 of the content management apparatus 3 adds the uploaded content file to the content file group GRA. The content file may include video data or still image data along with attribute data used for narrowing down the primary audience for the content file. Any kind of data can be included as the attribute data, but here it is assumed that the attribute data includes the preferred or target age, gender, and residential area of a content recipient (that is, to whom the content should be shown preferably). The provider of content is assumed to be, for example, a store operator, a product manufacturer, a wholesaler, or an advertisement agency. The processor 31 publishes each content file included in the content file group GRA on the communication network 200.

In order to use the smartphone POS service, a customer performs member registration with a provider of the smartphone POS service. With this member registration, an identifier for identifying the customer (hereinafter, referred to as a member code) is set, and the member database DBA is updated so as to include the various kinds of member information necessary for the customer to provide to use the smartphone POS service in association with the member code. The member information includes various types of attribute data such as age, sex, and residential area. In order to use the smartphone POS service, the customer installs the UI processing program PRB in a smartphone (or the like) owned by the customer to use the smartphone (or the like) as the user terminal 2. The customer starts the UI processing program PRB when entering a store at which the smartphone POS service is provided.

The processor 21 executes UI processing based on the UI processing program PRB.

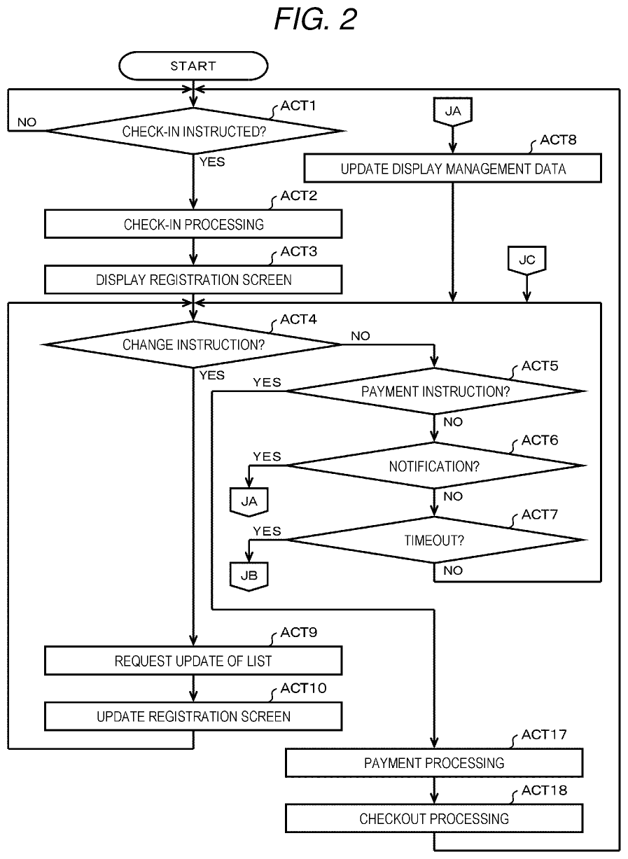

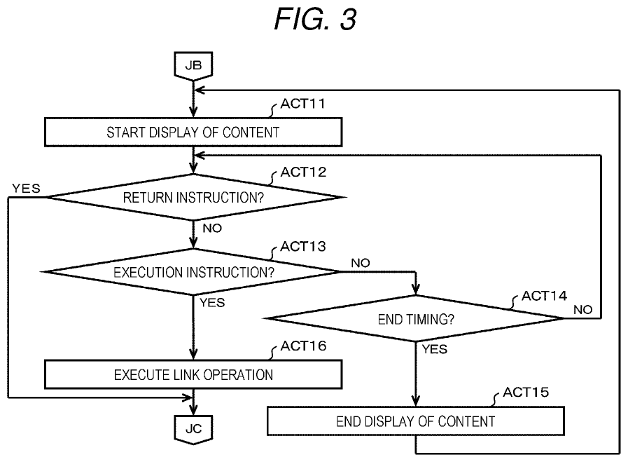

FIGS. 2 and 3 are flowcharts of the UI processing executed by the processor 21.

As ACT 1 in FIG. 2, the processor 21 waits for an instruction to check in. When a predetermined check-in event occurs, for example, when a two-dimensional check-in code displayed at the store is imaged by the camera 25, the processor 21 determines that check-in has been instructed, and proceeds to ACT 2.

As ACT 2, the processor 21 executes check-in processing for starting a transaction related to commodity purchase at a store at which the customer is entering. In the check-in processing, the processor 21 starts communication with the transaction processing apparatus 1 via the communication network 200, requests execution of the transaction processing, and transmits and receives various types of information for the transaction processing. The processor 21 notifies the transaction processing apparatus 1 of at least a member code associated with the customer who uses the user terminal 2.

When the user terminal 2 requests the start of the transaction processing as described above, the processor 11 of the transaction processing apparatus 1 starts the transaction processing based on the transaction processing program PRA. When transaction processing for another user terminal 2 is already being executed, the processor 21 starts new transaction processing in parallel with the other transaction processing.

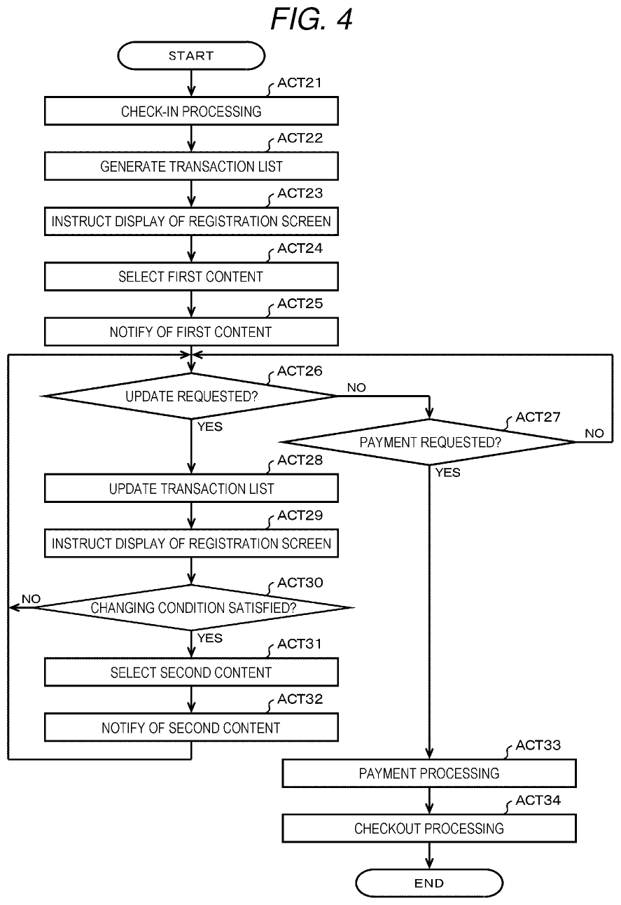

FIG. 4 is a flowchart of the transaction processing executed by the processor 11.

As ACT 21, the processor 11 starts check-in processing. That is, the processor 11 transmits and receives various types of information for the check-in processing executed by the processor 21 in user terminal 2.

As ACT 22, the processor 11 generates a transaction list. The transaction list is a list of commodities that have been registered for purchased using the user terminal 2. For example, the processor 11 generates list data in correlation with a transaction code as an identifier and stores the list data in the auxiliary storage unit 13. The processor 11 may also or instead store the list data in the main memory 12.

As ACT 23, the processor 11 instructs the user terminal 2 to display a merchandise registration screen showing a transaction registration status. For example, the processor 11 generates screen data representing a registration screen, and sends instruction data including the registration screen data to the user terminal 2. The instruction data is transmitted to the mobile communication unit 26 of the user terminal 2 via the communication network 200.

When the processor 21 of the user terminal 2 finishes the check-in processing in ACT 2 in FIG. 2, the processor 21 proceeds to ACT 3.

As ACT 3, the processor 21 causes the touch panel 24 to display the registration screen represented in the instruction data received by the mobile communication unit 26.

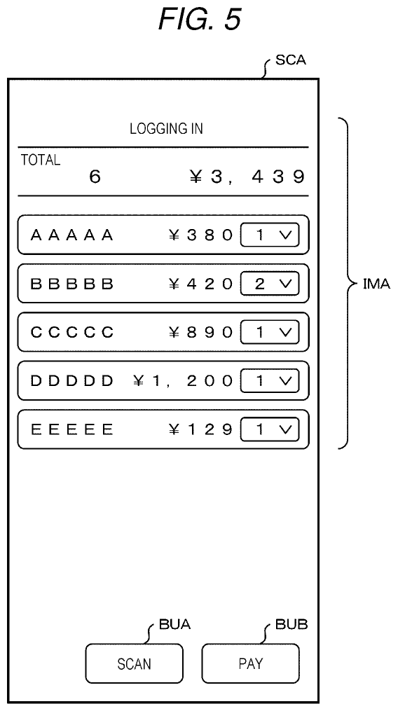

FIG. 5 is a diagram showing an example of a registration screen SCA after certain items have already been registered for purchase in the transaction.

The registration screen SCA shows an image IMA and buttons BUA and BUB. The image IMA shows details of the registered transaction. In the example of FIG. 5, the image IMA shows six commodities worth a total of 3,439 yen have been registered. That is, one item for each of the commodity names of “AAAAA”, “CCCCC”, “DDDDD”, and “EEEEEE” have been registered along with two items with a commodity name of “BBBBB” are included on the transaction list. The image IMA also shows that the unit price of commodity “AAAAA” is 380 yen, for example. Other unit prices for the other commodities are also shown. The button BUA is a soft key for receiving an instruction to shift to processing for scanning of another commodity to be registered in the transaction list. The button BUB is a soft key for receiving an instruction to shift to payment processing (e.g., a transaction closing button). The details shown by the image IMA change depending on a state of the transaction list. When transaction list does not yet include even one item, the image IMA would not show any commodity names and the displayed total number of items would be 0 and the total price would be 0 yen.

As ACT 4 in FIG. 2, the processor 21 checks whether a change instruction has been issued. If not, the processor 21 determines NO and proceeds to ACT 5.

As ACT 5, the processor 21 checks whether a payment instruction has been issued. If not, the processor 21 determines NO and proceeds to ACT 6.

As ACT 6, the processor 21 checks whether a notification has been issued. If not, the processor 21 determines NO and proceeds to ACT 7.

As ACT 7, the processor 21 checks whether a timeout time has been reached. If not, the processor 21 determines NO and returns to ACT 4.

Thus, as ACT 4 to ACT 7, the processor 21 waits for change instructions, payment instructions, or a notification to be made unless a timeout event occurs before the receiving of a change instruction, payment instruction, or a notification.

After the processor 11 of the transaction processing apparatus 1 instructs the display of the registration screen in ACT 23 in FIG. 4, the processor 11 proceeds to ACT 24.

As ACT 24, the processor 11 selects a content file (“first content”) to be displayed on the user terminal 2. For example, the processor 11 selects a content file best matching a preset first condition from among the content files published on the communication network 200 by the content management apparatus 3. If different content matches the first condition, the processor 11 may select any one or all as the first content. When no content matches the first condition, the processor 11 does not select any content file as the first content.

In some examples, the first content may be selected by the processor 21 in the user terminal 2 rather than the processor 11 in the transaction processing apparatus. In still other examples, the first content may be selected by the processor 31 of the content management apparatus 3 in response to a request from the processor 11 or the like.

In general, the first condition may be freely set by a developer of the transaction processing program PRA or a service administrator, or a user. The first condition for selecting the first content may be set or selected in consideration of the attribute data included in the member information of the customer.

As ACT 25, the processor 11 notifies the user terminal 2 of the selected first content. For example, the processor 11 acquires, from the content management apparatus 3, a uniform resource locator (URL) for accessing a content file corresponding to the first content, and sends, from the communication unit 14 to the user terminal 2 via the communication network 200, notification data indicating a URL of the first content in an identifiable manner. For example, when first content is not selected, the processor 11 notifies the user terminal 2 that there is no first content. When the first content is not selected, the processor 11 may skip ACT 25.

When the notification data related to the first content is transmitted to the user terminal 2 through the communication network 200, the mobile communication unit 26 receives the notification data. In response to this, the processor 21 determines YES in ACT 6 in FIG. 2 and proceeds to ACT 8.

As ACT 8, the processor 21 updates the display management data DAA. For example, when the processor 21 executes ACT 8 for the first time, the processor 21 generates the display management data DAA in which the URL in the notification data is represented as information related to the first content, and stores the display management data DAA in the auxiliary storage unit 23. Thereafter, the processor 21 returns to the standby state of ACT 4 to ACT 7.

When registering a new commodity for purchases, the customer touches, for example, the button BUA on the registration screen SCA and then captures an image of a barcode of the item with the camera 25. The customer may tap an area on the registration screen SCA where the quantity of the commodity is displayed to change the quantity of an item being purchased. If an operation for instructing the change of the transaction content is performed, the processor 21 determines YES in ACT 4 and proceeds to ACT 9.

As ACT 9, the processor 21 requests the transaction processing apparatus 1 to update the transaction list. For example, when a barcode of commodity is captured by the camera 25, the processor 21 requests adding of the commodity represented by the barcode. For example, when an instruction to change the quantity is given, the processor 21 requests to change the quantity with a notification of a commodity code and the changed quantity.

After the processor 11 finishes ACT 25 in FIG. 4, the processor 11 proceeds to ACT 26.

As ACT 26, the processor 11 checks whether an update of the transaction list is requested. If not, the processor 11 determines NO and proceeds to ACT 27.

As ACT 27, the processor 11 checks whether payment is requested. If not, the processor 11 determines NO and returns to ACT 26.

Thus, the processor 11 waits for an update request or a payment request in ACT 26 and ACT 27.

If the user terminal 2 requests an update of the transaction list, the processor 11 determines YES in ACT 26 and proceeds to ACT 28.

As ACT 28, the processor 11 updates the transaction list in response to the request from the user terminal 2. Accordingly, the processor 11 registers an item as a transaction target (includes the item on the registered item/transaction list) in response to the operation on the user terminal 2. Thus, the processor 11 executes the information processing based on the transaction processing program PRA and functions as a registration unit.

As ACT 29, the processor 11 instructs the user terminal 2 to display a registration screen showing the transaction registration status. That is, the processor 11 generates a registration screen corresponding to the updated transaction list and instructs the user terminal 2 to display the registration screen.

As ACT 30, the processor 11 checks whether a condition for changing content is satisfied. If so, the processor 11 determines YES and proceeds to ACT 31.

As ACT 31, the processor 11 selects “second content”. The second content in this context is another one of the content files (or information corresponding thereto) that can be displayed on the user terminal 2. For example, the processor 11 selects a content file matching a predetermined second condition from among the content files published on the communication network 200 by the content management apparatus 3. If more than one content file matches the second condition are found, the processor 11 may select all as the second content or may select only subset of the matching content. The processor 11 does not have to select a content file as the second content when no content matching the second condition is found.

In some examples, the second content may be selected by the processor 31 of the content management apparatus 3 in response to a request from the processor 11.

The second condition may be freely set by, for example, the developer of the transaction processing program PRA. The second condition may be set in consideration of the registered items on a transaction list. The second condition may be based on both the transaction list and the attribute data of the customer. In the present embodiment, the second condition is set such that the second content is not selected if no item is presently included on the transaction list.

As ACT 32, the processor 11 notifies the user terminal 2 of the selected second content (if any). For example, the processor 11 acquires, from the content management apparatus 3, a URL for accessing a content file corresponding to the second content, and sends notification data indicating the URL of the second content in an identifiable manner. If second content is not selected, the processor 11 may notify the user terminal 2 that there is no second content or may skip ACT 32. The processor 11 then returns to the standby state of ACT 26 and ACT 27.

The processor 11 selects the second content in consideration of the content of the transaction list. Therefore, when the transaction list is updated, additional or new second content may be selected in view of the updated transaction list. That is, the processor 11 may check whether a change condition has been satisfied and determine YES in ACT 30 if so and proceeds to ACT 31 or if a change condition is not satisfied, the processor 11 determines NO in ACT 30, then skips ACT 31 and ACT 32, and returns to the standby state of ACT 26 and ACT 27. In general, the change condition(s) may be freely selected or set by, for example, the developer of the transaction processing program PRA. Note that, in some examples, the determination process in ACT 30 may be omitted, and in such examples second content may be selected in ACT 31 whenever content of the transaction list is updated. In such a case, the processor 11 may skip ACT 32 if there has been no change in the selected second content selected in ACT 31.

When the notification data related to the second content is received by the mobile communication unit 26, the processor 21 determines YES in ACT 6 (see FIG. 2) and proceeds to ACT 8. In ACT 8, the processor 21 updates the display management data DAA stored in the auxiliary storage unit 23 such that the URL represented in the notification data added.

When an elapsed time after an advance from ACT 3 to ACT 4 without receiving of a change instruction, a payment instruction, or a notification of second content exceeds a predetermined time, the processor 21 determines that a timeout event has occurred in ACT 7 and proceeds to ACT 11 (see FIG. 3). The period in which the processor 21 is in the standby state of ACT 4 to ACT 7 in FIG. 2 corresponds to the period in which the customer performs operations related to merchandise registration. However, when the processor 21 determines YES in ACT 7 (a timeout event occurs), the processor 21 considers that a non-operation state in which the operations related to merchandise registration are no longer being performed has occurred. Thus, when the processor 21 executes the information processing based on the UI processing program PRB, the processor 21 functions as a timeout detection unit.

In ACT 4 to ACT 7, the processor 21 may wait in a standby state for a specified time before determining a non-operation state has been entered.

As ACT 11, the processor 21 starts the display of the content. For example, the processor 21 selects one of the URLs in the display management data DAA by a predetermined selection rule, and then acquires a content file from the content management apparatus 3 (via the communication network 200) based on the URL. Then, the processor 21 causes the touch panel 24 to display the content of the acquired content file. For example, if the content file is provided as a streaming video, the processor 21 performs streaming reproduction of the video. For example, if the content file is a downloadable video, the processor 21 downloads and then plays the content file. For example, if the content file is a still image file, the processor 21 displays the still image from the content file. If the content file includes audio data instead of or in addition to image/video data, the processor 21 may cause an audio device to output audio based on the audio data. Thus, when the processor 21 executes the information processing based on the UI processing program PRB, the processor 21 functions as a display control unit.

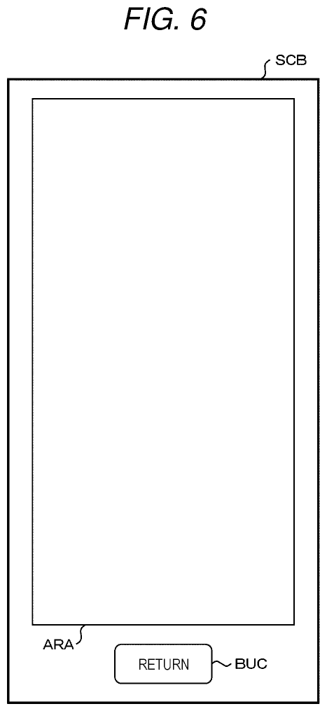

FIG. 6 is a diagram showing an example of a display screen SCB on the touch panel 24 during a content display.

The processor 21 displays an image corresponding to a content file in an area ARA that occupies most of a displayable area of the touch panel 24. The processor 21 displays the button BUC outside the area ARA. The button BUC is a soft key for receiving an instruction to return the display on the touch panel 24 to the registration screen SCA.

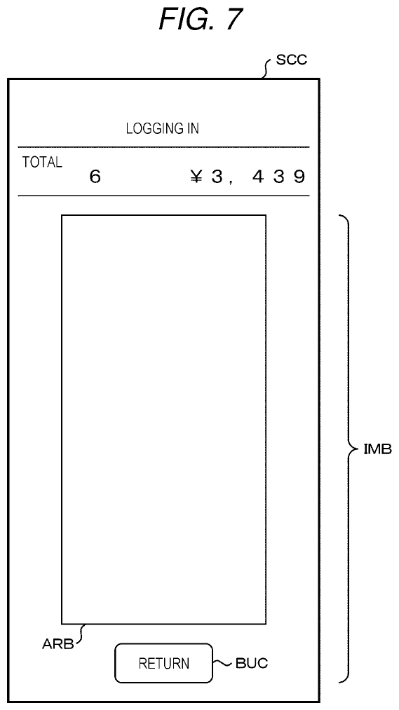

FIG. 7 is a diagram showing an example of a display screen SCC of the touch panel 24 during content display.

The processor 21 displays an image region IMB while still showing the total number of registered items and the total amount due of the registration screen SCA remains. The processor 21 displays an image corresponding to the content file in an area ARB in the image region IMB and displays a button BUC outside the area ARB.

The display screen during content display may be in other formats other than these examples. The display screen may be set appropriately by, for example, the developer of the UI processing program PRB. Alternatively, any one of a plurality of possible display modes or formats may be adopted according to a user setting or preference.

As ACT 12, the processor 21 checks whether a return instruction has been issued. If not, the processor 21 determines NO and proceeds to ACT 13.

As ACT 13, the processor 21 checks whether an execution instruction has been issued. If not, the processor 21 determines NO and proceeds to ACT 14.

As ACT 14, the processor 21 checks whether an end timing has been reached. If not, the processor 21 determines NO and returns to ACT 12.

Thus, as ACT 12 to ACT 14, the processor 21 waits for a return instruction, an execution instruction or an end time.

For example, if the content is a video, the end time may be when the video ends (has been fully played). For example, if the content is a still image, the end time may be some preset display period. The end time may be defined in the UI processing program PRB or may be determined for each content. Setting data indicating the end time for a particular content file may be included in (or otherwise associated with) each content file. If the end time is reached, the processor 21 determines YES in ACT 14 and proceeds to ACT 15.

As ACT 15, the processor 21 ends the display of the particular content file. Then, the processor 21 repeats the processing of ACT 11 in the same manner as described above. The rule for selecting one of the URLs represented in the display management data DAA in ACT 11 may be appropriately set by, for example, the developer of the UI processing program PRB. Alternatively, any one of a plurality of rules defined by the developer of the UI processing program PRB may be applied according to a user setting.

For example, if the display management data DAA includes a URL related to the first content and a URL related to the second content, the rule may be such that a URL related to first content and a URL related to second content are alternately selected. In other examples, the selection rule may be based on a priority setting for either first content or second content. For example, the second content may be preferentially selected. Content may be selected in sequence order related to a time when added to the display management data DAA. In some examples, when the display management data DAA includes a plurality of URLs related to second content, the URLs of the second content can be sequentially selected.

The user terminal 2 displays a content screen showing first content and second content selected by the processor 11 of the transaction processing apparatus 1. That is, the selection of the first content corresponds to the selection of a content screen to be displayed on the user terminal 2 from among a plurality of candidate content screens in accordance with an attribute or characteristic of the customer operating the user terminal 2. The selection of the second content as performed by the processor 11 may be made in accordance with one or more registered items being placed on the transaction list. Thus, when the processor 11 executes the information processing based on the transaction processing program PRA, t the processor 11 functions as a content selection unit.

When a customer is interested in content displayed on the touch panel 24, the customer may perform a predetermined operation such as tapping on a display area of the content. Assuming link information is set for the content being presently displayed is recorded in a content file when the predetermined operation is performed, the processor 21 determines YES in ACT 13 and proceeds to ACT 16.

As ACT 16, the processor 21 executes an operation defined by the link information. The operation is, for example, display of a web page. Then, after the link operation is ended, the processor 21 returns to the standby state of ACT 4 to ACT 7 in FIG. 2.

When a customer wants to return the display screen of the touch panel 24 to the registration screen SCA, the customer instructs the return by a predetermined operation such as tapping the button BUC. The processor 21 then determines YES in ACT 12, and returns to the standby state of ACT 4 to ACT 7 in FIG. 2.

If a customer desires to proceed to payment, the customer instructs payment by a predetermined operation such as tapping the button BUB on the registration screen SCA. In response to this, the processor 21 determines YES in ACT 5 in FIG. 2 and proceeds to ACT 17.

As ACT 17, the processor 21 executes the payment processing. For example, the processor 21 requests the transaction processing apparatus 1 to perform operations related to making of a payment, and then executes processing for paying for a transaction in cooperation with the transaction processing executed by the processor 11.

When the user terminal 2 requests to make a payment (close the transaction), the processor 11 of the transaction processing apparatus 1 determines YES in ACT 27 (see FIG. 4) and proceeds to ACT 33.

As ACT 33, the processor 11 executes processing related to payments for the transaction in cooperation with the payment processing executed by the processor 21.

As ACT 34, the processor 11 executes checkout processing for ending the use of the smartphone POS service by the user terminal 2.

As ACT 18 (see FIG. 2), the processor 21 executes checkout processing for ending the use of the smartphone POS service in cooperation with the checkout processing executed by the processor 11.

The payment processing and the checkout processing executed by the processor 11 and the processor 21 may be similar to, for example, processing performed in standard smartphone POS services.

Then, when the processor 21 finishes the checkout processing, the processor 21 ends the transaction processing and returns to the standby state of ACT 1 in FIG. 2.

As described above, the transaction processing system 100 changes a screen of the touch panel 24 from the registration screen SCA to a screen showing content such as the display screen SCB and the display screen SCC during a period when neither an instruction to change the transaction content nor an instruction for payment is input at the user terminal 2 in a predetermined time. Thus, information for sales promotion is provided to a customer who is in a store and looking around for items to purchase, using the user terminal 2 as a user interface for transaction processing.

The transaction processing system 100 selects the first content under a first condition in consideration of the attribute data of the customer. Thus, with the display of the first content, information corresponding to the attribute of the customer can be provided.

The transaction processing system 100 selects the second content according to a second condition in consideration of the content of the transaction list. Thus, with the display of the second content, it is possible to provide information corresponding to the content of the transaction list, that is, a commodity that has just been registered for purchase.

The transaction processing system 100 sets both the first content and the second content to be display targets in the non-operation state. Then, the transaction processing system 100 does not select second content when there is no commodity on the transaction list. Thus, when content selection cannot be based registered items, information corresponding to an attribute of the customer can be provided.

The first content and the second content are sequentially displayed in the non-operation state in a situation in which both the first content and the second content are selected in the transaction processing system 100. Thus, the provision of information corresponding to the attribute of the customer and the provision of information corresponding to the commodity to be a transaction target may be performed in a time division manner, and both types of information provision can be performed if the non-operation state is sufficiently prolonged.

### Modifications

The transaction list may be generated and updated by the processor 21 of the user terminal 2 and stored in the auxiliary storage unit 23. That is, the registration unit may be implemented as a function of the processor 21. Alternatively, regarding the transaction list, a copy equivalent to the transaction list stored in the auxiliary storage unit 13 of the transaction processing apparatus 1 may be stored in the auxiliary storage unit 23 of the user terminal 2. In these cases, the selection of the second content may be performed by the processor 21 of the user terminal 2.

In some examples, the processor 11 of the transaction processing apparatus 1 may detect the non-operation state based on the duration of the standby state in ACT 26 and ACT 27. That is, the detection unit may be implemented as a function of the processor 11.

The processor 11 of the transaction processing apparatus 1 may generate screen data for a screen showing promotional content, and the transaction processing apparatus 1 may request the user terminal 2 to display a screen based on the generated screen data. That is, the display control unit may be implemented as a function of the processor 11.

In some examples, the system may only display one of the first content or the second content types. That is, processing specifically associated with one or the other of content types may be omitted. For example, ACT 24 to ACT 25 or ACT 30 to ACT 32 may be omitted.

The functions of the transaction processing apparatus 1 and the content management apparatus 3 may be implemented in one information processing apparatus. Alternatively, the functions of the transaction processing apparatus 1 and/or the content management apparatus 3 may be implemented by distributed processing executed by a plurality of information processing apparatuses.

Some or all of the functions described above as implemented by the processor 11 or the processor 21 through software execution or the like may be implemented by hardware that executes substantially similar information processing via a dedicated circuit, such as a logic circuit. The described functions may also be implemented by combining software control with the hardware such as the logic circuit.

While certain embodiments have been described, these embodiments have been presented by way of example only, and are not intended to limit the scope of the disclosure. Indeed, the embodiments described herein may be embodied in a variety of other forms; furthermore, various omissions, substitutions and changes in the form of the embodiments described herein may be made without departing from the spirit of the disclosure. The embodiments and the modification thereof are included in the scope and the spirit of the disclosure and are also included in the invention described in the scope of claims and an equivalent scope thereof.

What is claimed is:

1. A retail store transaction processing system, comprising:
a content management apparatus configured to store a plurality of content files; and
a transaction processing apparatus communicatively connected to the content management apparatus and configured to:
register a commodity in a transaction based on registration input received from a user terminal device,
select a content file to be displayed on the user terminal from the plurality of content files stored on the content management apparatus, the content file being selected based on at least one of a user attribute associated with a user of the user terminal device and a commodity that has been registered in the transaction, and
during the transaction, detect when a length of time since a registration input has been received from the user terminal device without receiving another registration input or user instruction exceeds a timeout period and cause the user terminal device to display information corresponding to the selected content file after the length of time exceeds the timeout period.

2. The system according to claim 1, wherein the transaction processing apparatus is further configured to:
select a first content file from the plurality of content files based on the user attribute,
select a second content file from the plurality of content files based on the commodity that has been registered, and
cause the user terminal to display information corresponding to the first and second content files in sequence after the length of time exceeds the timeout period.

3. The system according to claim 1, wherein the transaction processing apparatus supplies a URL for the selected content file to the user terminal device to cause the user terminal device to display information corresponding to the selected content file.

4. The system according to claim 3, wherein the URL points to the selected content file stored on the content management apparatus.

5. The system according to claim 1, wherein the transaction processing apparatus and the content management apparatus are separate server devices.

6. The system according to claim 1, wherein the transaction processing apparatus selects another content file after information corresponding to a previously selected content file has been displayed on the user terminal device.

7. A transaction processing apparatus for a retail store transaction processing system, the transaction processing apparatus comprising:
a communication interface communicatively connected to a content management apparatus storing a plurality of content files; and
a processor configured to:
register a commodity in a transaction based on registration input received from a user terminal device,
select a content file to be displayed on the user terminal from the plurality of content files stored on the content management apparatus, the content file being selected based on at least one of a user attribute associated with a user of the user terminal device and a commodity that has been registered in the transaction, and
during the transaction, detect when a length of time since a registration input has been received from the user terminal device without receiving another registration input or user instruction exceeds a timeout period and cause the user terminal device to display information corresponding to the selected content file after the length of time exceeds the timeout period.

8. The transaction processing apparatus according to claim 7, wherein the processor is further configured to:
select a first content file from the plurality of content files based on the user attribute,
select a second content file from the plurality of content files based on the commodity that has been registered, and
cause the user terminal to display information corresponding to the first and second content files in sequence after the length of time exceeds the timeout period.

9. The transaction processing apparatus according to claim 7, wherein the processor supplies a URL for the selected content file to the user terminal device to cause the user terminal device to display information corresponding to the selected content file.

10. The transaction processing apparatus according to claim 9, wherein the URL points to the selected content file stored on the content management apparatus.

11. The transaction processing apparatus according to claim 7, wherein the content management apparatus is a server device.

12. The transaction processing apparatus according to claim 7, wherein the processor selects another content file after information corresponding to a previously selected content file has been displayed on the user terminal device.

13. The transaction processing apparatus according to claim 7, wherein the processor is further configured to:
select a first content file from the plurality of content files based on the user attribute,
select a second content file from the plurality of content files based on the commodity that has been registered, and
cause the user terminal to display information corresponding to the first and second content files in sequence after the length of time exceeds the timeout period.

14. A non-transitory, computer-readable medium storing program instructions which when executed by a transaction processing apparatus of retail store transaction processing system causes the transaction processing apparatus to perform a method comprising:
registering a commodity in a transaction based on registration input received from a user terminal device;
selecting a content file to be displayed on the user terminal from a plurality of content files stored on a content management apparatus, the content file being selected based on at least one of a user attribute associated with a user of the user terminal device and a commodity that has been registered in the transaction; and
during the transaction, detecting when a length of time since a registration input has been received from the user terminal device without receiving another registration input or user instruction exceeds a timeout period and causing the user terminal device to display information corresponding to the selected content file after the length of time exceeds the timeout period.

15. The non-transitory, computer-readable medium according to claim 14, the method further comprising:
selecting a first content file from the plurality of content files based on the user attribute;
selecting a second content file from the plurality of content files based on the commodity that has been registered; and
causing the user terminal to display information corresponding to the first and second content files in sequence after the length of time exceeds the timeout period.

16. The non-transitory, computer-readable medium according to claim 14, wherein a URL for the selected content file is supplied to the user terminal device to cause the user terminal device to display information corresponding to the selected content file.

17. The non-transitory, computer-readable medium according to claim 16, wherein the URL points to the selected content file stored on the content management apparatus.

18. The non-transitory, computer-readable medium according to claim 14, the method further comprising:
selecting another content file after information corresponding to a previously selected content file has been displayed on the user terminal device.

19. The non-transitory, computer-readable medium according to claim 14, wherein the selected content file is a promotional advertisement.

20. The non-transitory, computer-readable medium according to claim 14, wherein the content file is selected based only a commodity that has been registered in the transaction.
